(19) United States
(12) Patent Application Publication
(10) Pub. No.: US 2006/0056126 A1
(43) Pub. Date: Mar. 16, 2006

(54) Weather-resistant surge protector plug

(76) Inventor: Edward Meltzer, Laguna Niguel, CA (US)

Correspondence Address: Brian L. Wamsley;Goodwin Procter LLP, 599 Lexington Avenue, New York, NY, 10022, US

(21) Appl. No.: 10/941,166

(22) Filed: Sep. 15, 2004

(51) Int. Cl. H02H 9/06

(52) U.S. Cl. 361/118

(57) ABSTRACT

The specification discloses a weather-resistant surge protector plug for protecting an outdoor electrical device connected on its load side from spurious or excessive transient voltages or surges or both on an electrical line above a predetermined value, on its line side or its hot side. The surge protector plug contains, within the plug housing, an MOV and an on/off switch having a re-settable circuit breaker. The on/off switch acts to interrupt current to the device at the option of the user, and also to re-set the circuit breaker after the occurrence of an overvoltage condition. An indicator light indicates whether the switch is on or off. The plug housing is made of weather-resistant and materials and is further designed and constructed to be water or moisture resistant. An electrical circuit is are also disclosed. The lightning and surge protection as provided by this invention may also be rendered into a sold state chip device.

### BACKGROUND OF THE INVENTION

1. Field of the Invention

The present invention relates generally to an apparatus for protecting devices connected to AC power lines, and more particularly to a plug containing a surge protector for protection of those devices using a common ground. More specifically, the present invention relates to an outdoor or weather-resistant plug containing a surge protector which can be used at the end of an AC electrical power cord or extension cord.

2. Discussion of the Related Art

Today, many homes use appliances, power tools, lights, electronic devices and the like that require protection from overvoltage conditions and electrical surges. Many of these devices are used out-of-doors. Lightning is a major source of overvoltage conditions on residential wiring. The overvoltage condition can result from a direct lightning strike or it can be induced in the AC transmission lines by a nearby lightning strike. Each year, thousands of homes and businesses are damaged or destroyed by lightning and, in 1990, residential claims for lightning damage exceeded one billion dollars.

Overvoltage conditions can also result from power line crosses caused, for example, by a vehicle striking a utility pole. Transients (voltage spikes) are caused by the utility company when it switches capacitor banks on and off line in order to correct the power factor (VI cos θ). Transients can also originate within the home when inductive loads such as electric motors are switched. Transients can also result from switching non-inductive loads and can be induced on wiring in the home.

Overvoltage conditions can also result from the loss of the AC neutral. If that occurs, devices that are normally connected to 110 to 120 volts AC are subjected to 220 to 240 volts AC. The loss of the AC neutral can result from corrosion of the meter pan at the service entrance where the meter is located outside the building and is exposed to the elements. Most plug-in secondary surge suppressors being sold today are not designed to withstand the loss of the AC neutral and may create a fire hazard when the AC neutral is lost.

Many homeowners attempt to protect their valuable power tools, appliances and electronic equipment with plug-in surge suppressors. Such devices do not protect equipment from the large amplitude pulses caused by lightning strikes, although they do offer some protection against low energy transients originating within the home. Moreover, plug-in surge suppressors are generally located far from the earth ground where the electric utilities are brought into the building. A surge suppressor is only as good as the ground to which it is connected. A plug-in surge suppressor which protects both AC power lines and telephone lines is shown in U.S. Pat. No. 4,438,477 issued to Cawley on Mar. 20, 1984.

Plug-in surge suppressors sold prior to 1998 had to meet the requirements of Underwriters Laboratories Standard 1449, First Edition (“UL 1449 Ed 1”) dated Aug. 28, 1985. On Aug. 15, 1996 UL 1449 Second Edition (“UL 1449 Ed 2”) was released and became effective Feb. 16, 1998. UL 1449 Ed 2 requires new tests that were not required by UL 1449 Ed 1. For example, a new test that must be passed to qualify under UL 1449 Ed 2 is that a plug-in surge suppressor must not create a fire hazard in the event the AC neutral is lost.

In addition to the need for plug-in surge suppressors that will meet UL 1449 Ed 2, there is also a need for surge suppressors that will meet UL 1449 Ed 2 and that will protect power tools, appliances, and electronic devices, including such devices that are used outdoors. Further, there is a need for an outdoor surge protector that is portable and dedicated to the individual electrical device, without having to be installed within the electrical device itself. There is also a need for a surge protector that is part of the actual electrical plug itself. Such a surge-protector plug would be versatile and highly portable in that, when used as the plug for an extension cord for example, could easily be switched from one power tool to another. Such a surge-protector plug need also be weather-resistant or weather-proof to be used in outdoor applications.

Many surge and lightning protection products are currently available on the market today but none of them provide reliable surge and lightning protection above and beyond providing one to three MOVs, and except perhaps warn you by way of a little light or a buzzer indicating that the MOV has failed, and that now you are without surge and lightning protection. Thus these sacrificial devices leave you without protection when you need them most. None of them are designed to protect the equipment to be protected and the unit itself so that it takes advantage of a solid state switch or an electromechanical switch as an inexpensive fault tolerant isolation means to provide an improved surge and lightning protection. In addition, the typical plug-in surge protector device available today, such as a power strip providing multiple plug outlets, is not designed for outdoor use and is not weather-resistant.

The present invention provides the following advantages over the devices currently available in the market:
1) it is relatively inexpensive and provides continued superior quality surge and lightning protection.
2) It is designed to provide continuous usage and protection as compared to other products that leave the equipment unprotected, (and at best only indicate or inform the user that it has failed and is no longer protecting your equipment. They are designed to be thrown away.)
3) It additionally provides continuous over-voltage protection, providing isolation for the equipment or the protected line from the source until the over-voltage condition has subsided;
4) Eliminates the serious problem of leaving the equipment without protection, just when the protection is needed the most, as in the situation of surges, lightning and thunder storm conditions.
5) It is easy to maintain and restore back into service.
6) It is weather-resistant and can be used outdoors to protect outdoor power tools and other electric devices.
7) It is versatile and adaptable to be used at the end of an extension cord or as the plug on the electrical cord of the device to be protected.

The present invention is described more particularly in the summary and the detailed description as follows:

### SUMMARY OF THE INVENTION

The present invention provides, in an individual electrical plug, a surge suppressor which is effective in protecting electric power tools, electronic equipment and human beings from the dangers associated with overvoltage conditions, particularly those caused by lightning and the loss of the AC neutral, and which meets the more stringent requirements of UL 1449 Ed 2.

The present invention also provides a plug surge suppressor which will meet the requirements of UL 1449 Ed 2 and which may be dedicated to an individual electric power tool or electronic device by placement at the end of the power cord or by using an extension cord having the present invention as the plug, without incorporation into the device itself, to protect those devices from overvoltage conditions appearing on AC power lines.

The present invention significantly reduces the likelihood that a fire will result from an overvoltage condition or a component failure in the surge suppressor.

In accordance with the present invention the surge protection is provided in an electrical plug containing a single MOV and a circuit-breaker switch. The principle adopted in the surge protector plug is that the system automatically shuts off the flows of current to the equipment to be protected by deactivating a solid state switch, circuit breaker or an electromechanical relay means, when a serious surge, transient or lightning presents itself and would otherwise endanger the integrity of the surge protector and the equipment. When the current, which is through the plug, reaches twice the rated current of the switch, the switch will automatically cut off within 0-30 seconds to protect the device. The plug will be kept in the operational state at the normal voltage (120V, 60 HZ of the sine wave). When the effective value of the sine wave voltage exceeds 200V, the MOV will immediately change to be connected from the shut-off circuit state. The large current through the MOV will make the switch cut off to protect the device. When the overvoltage condition has passed, the switch can be turned back on, thus supplying current to the electrical device and re-activating the surge-protector. Alternatively, the switch can be placed in the “off” position regardless of whether or not an overvoltage condition has occurred. Thus the switch may also operate as a simple on/off switch for the electrical device.

Also in accordance with the invention the surge-protector plug is manufactured from weather resistant materials such as plastic or hard rubber, and further weather-resistant seals and switch covers are used, as will be further described.

The subject matter which I regard as my invention is more particularly pointed out in the claims at the end of the specification. The invention, including its method of operation and its numerous advantages, may best be understood by reference to the following description taken in connection with the accompanying drawings wherein like reference numerals refer to like components.

### BRIEF DESCRIPTION OF THE DRAWINGS

FIG. 1 is a schematic of an AC overvoltage protection circuit for use with the present invention; and

FIG. 2 is an exploded view illustrating the weather-resistant surge protector using a solid state switch and MOV.

### DESCRIPTION OF THE PREFERRED EMBODIMENTS

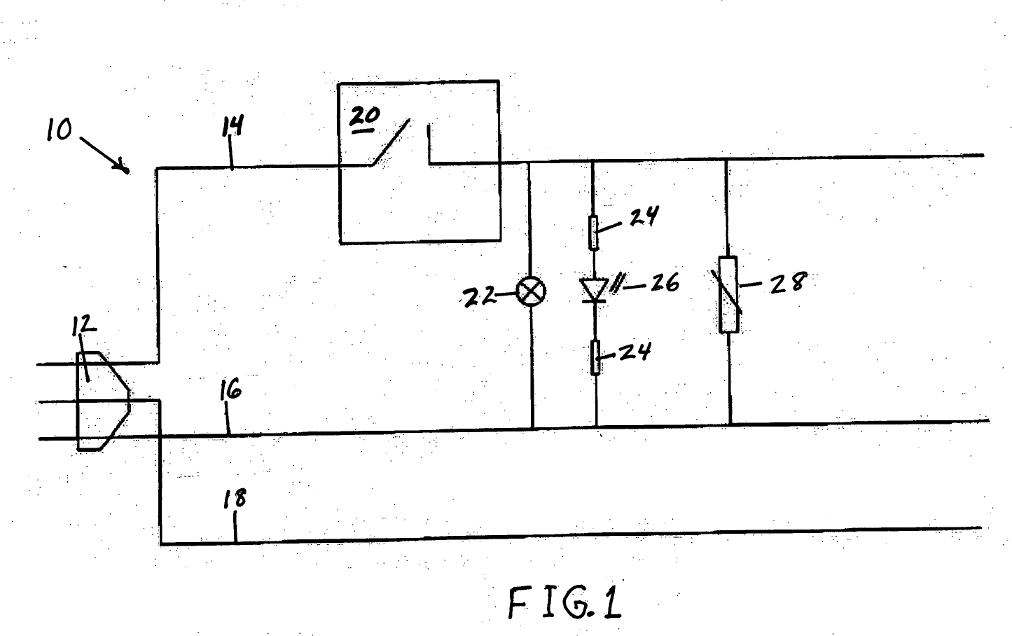

FIG. 1 is a schematic diagram of surge protector plug overvoltage protection circuit 10 according to the present invention. The overvoltage protection circuit 10 comprises a three-prong male AC plug 12 which is adapted to plug into an AC outlet. The overvoltage protection circuit 10 has three conductors: AC line 14, AC neutral 16 and ground 18. The ends of the three conductors opposite plug 12 may terminate either with a female plug (not shown) as would be the case where the surge protector plug is used with an extension cord, or in connection with an electrical appliance, device or power tool (also not shown). The overvoltage protection circuit 10 has an on/off switch with a build in circuit breaker (“S/C/B switch”)20, placed in series with the surge protection circuitry. S/C/B switch 20 may be a solid state switch, or an electro-mechanical relay means. S/C/B switch 20 also contains an internal indicator light 22, shown as part of the surge protection circuitry as connected between AC line 14 and ground 16. Indicator light 22 tells the user whether or not the power is on, indicating whether the switch is off or the circuit breaker has been tripped. In parallel arrangement with indicator light 22, there is also connected between AC line 14 and ground 16, two 15 K resistors 24 in series with LED 26 such that LED 26 is located between the resistors 24. The overvoltage protection circuit 10 also contains in parallel arrangement with indicator light 22 and resistors 24, and LED 26, an MOV 28 connected between AC line 14 and ground 16. Although only a single MOV is shown, and may be sufficient for most applications, it is contemplated and within the scope of this invention that multiple MOV's may be used. Overvoltage protection circuit 10 may take other similar forms which would be within the scope of the present invention. In addition, it is contemplated to be within the scope of this invention that any or all of the electrical components of the surge protector plug may be in solid stat form, i.e., in chip form.

The principle adopted in the surge protector plug overvoltage protection circuit 10 is that the system automatically shuts off the flow of current to the equipment to be protected by deactivating S/C/B switch 20, when a serious surge, transient or lightning presents itself and would otherwise endanger the integrity of the surge protector and the equipment. When the current on the line side of the surge protector plug, which is through plug 12, reaches twice the rated current of the switch, the switch will automatically cut off the current to the load side of the surge protector plug within 0-30 seconds to protect the device. Plug 12 will be kept in the operational state at the normal voltage (120V, 60 HZ of the sine wave). When the effective value of the sine wave voltage exceeds 200V, MOV 28 will immediately change to be connected from the shut-off circuit state. The large current through MOV 28 will make the switch 20 cut off to protect the device. When that happens, LED 26, which is in the “on” or “lighted” position, is also switched off, indicating to the user that an overvoltage situation has occurred, the current has been switched off and surge protector plug must be turned back on and reactivated. When the overvoltage condition has passed, switch 20 can be turned back on, thus supplying current to the electrical device and re-activating the surge-protector. Alternatively, switch 20 can be placed in the “off” position regardless of whether or not an overvoltage condition has occurred. Thus switch 20 may also operate as a simple on/off switch for the electrical device.

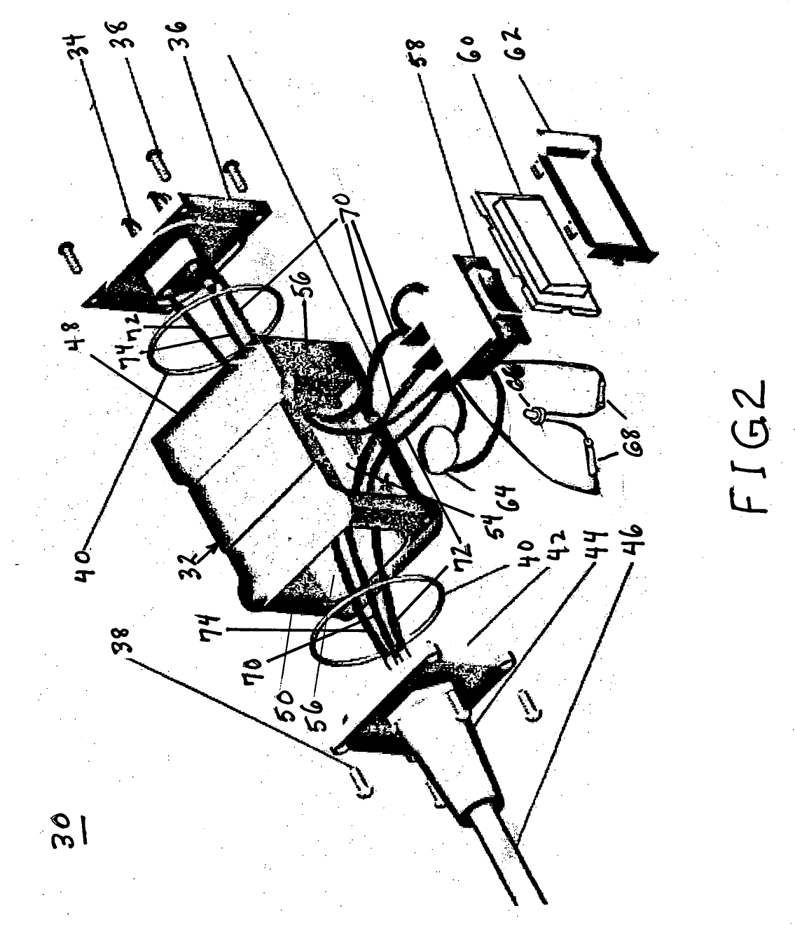

FIG. 2 is an exploded view illustrating the weather-resistant surge protector plug 30. The surge protector plug 30 is made of a solid, weather resistant housing 32 of a material that is water proof and will not rust or corrode, such as a heavy rubber or plastic. Housing 32 contains internally all of the electrical components of plug 30 when assembled. Housing 32 has essentially three openings 52, 54, 56 for accommodating the wiring to the three-prong male AC plug 34 and electrical cord 46. At one end of the housing 32 there is located a three-prong male AC plug 34 fashioned as part of a plate 36 for connection to one end of the housing 48. Plate 36 can be fastened to housing 32 by means of screws 38. The wires connecting the AC plug 32 pass into plug housing 32 through opening 56. A seal ring 40 is placed between plate 36 and housing 32 as protection against moisture or water, thus making the connection of plate 36 and housing 32 weather proof. If desired, sealant compound (not shown) may also be used to further insure protection against water.

At the other end of the housing 50 opposite the plug 34 is a second plate 42, the outside portion of which is connected to a power cord 46, which may be a power cord to an electrical device, an extension cord or the like. Power cord 46 is connected to second plate 42 by means of a strain relief mechanism 44, which allows stress to be placed on the cord 46 without affecting plug 32. The wires to the cord 46 pass into plug housing 32 through opening 56. The second plate 42 is similarly connected to plug housing 32 using screws 38 and seal ring 40.

The wires inside the plug housing 32 engage the S/C/B switch 58, which is further connected in series to the MOV 64 (and also LED 66 and resistors 68). S/C/B switch 58 is positioned within opening 54 of the plug 32, when properly assembled. S/C/B switch 58 can also be provided with a switch seal 60, to provide protection against moisture and water, and a switch cover 62 cover the seal 60 and S/C/B switch 58. The above described components of the surge protector plug are connected in accordance with the schematic of FIG. 1 by the AC line 70, neutral line 72 and ground line 74 as further shown in FIG. 2.

While the present invention has been described by reference to various preferred embodiments, it will be understood by persons skilled in the art that many modifications and variations may be made in those preferred embodiments without departing from the spirit and scope of the present invention. Accordingly, it is intended that the invention not be limited to the disclosed preferred embodiments, but that it gave the full scope permitted by the following claims.

I claim:

1. A surge protector comprising a line side and a load side, for protecting an electrical device or an electronic equipment connected to said load side of the surge protector plug, from spurious or excessive transient voltages or surges or both on said line side of the surge protector, that are above a predetermined value, on said line side of the surge protector, the surge protector plug further comprising
(a) at least one switch means series mounted between said line side and said equipment on said load side, wherein said switch means is responsive to a signal that allows or interrupts a flow of current through said switch means, to said equipment on said load side of the surge protector plug, thus isolating said equipment from the transients and surges on said line side of the surge protector;
(b) at least one current responsive means connected to a hot or a positive line of said line side of the surge protector plug, wherein said current responsive means responds to a fault condition that exceeds said predetermined value, due to a surge voltage or current into at least one over voltage detection or suppression means connected across said positive line of said line side and an earth ground, return line or neutral line on said line side of the surge protector plug,
(c) wherein said over voltage protection means is further connected to said switch means, and disables said switch means, thus disabling the flow of current flowing through said switch means to said equipment on said load side, when said current responsive means blows or disengages due to said surge voltage or current exceeding said predetermined value.

2. A surge protector plug as claimed in claim 1, wherein said switch means is an electromechanical device.

3. A surge protector plug as claimed in claim 1, wherein said switch means a solid-state switch means.

4. A surge protector plug as claimed in claim 1, wherein said current responsive means is a manually resettable, mechanical or electromechanical circuit-breaker.

5. A surge protector plug as claimed in claim 1, wherein said switch means and said current responsive means is a circuit breaker switch.

6. A surge protector plug as claimed in claim 1, wherein said at least one over voltage detection or suppression means is a Metal Oxide Varistor (MOV).

7. A surge protector plug as claimed in claim 1, wherein the surge protector plug further includes an indicator connected across said load side and said earth ground to indicate a presence of power.

8. A method for providing protection of an electrical device or an electronic equipment connected to said load side of the surge protector plug, from spurious or excessive transient voltages or surges or both on said line side of the surge protector plug, that are above a predetermined value, on said line side of the surge protector plug, comprising connecting a surge protector plug to the device or equipment, said surge protector further comprising:
(a) at least one switch means series mounted between said line side and said equipment on said load side, wherein said switch means is responsive to a signal that allows or interrupts a flow of current through said switch means, to said equipment on said load side of the surge protector plug, thus isolating said equipment from the transients and surges on said line side of the surge protector plug:
(b) at least one current responsive means connected to a hot or a positive line of said line side of the surge protector plug, wherein said current responsive means responds to a fault condition that exceeds said predetermined value, due to a surge voltage or current into at least one over voltage detection or suppression means connected across said positive line of said line and an earth ground, return line or a neutral line on said line side of the surge protector plug,
(c) wherein said over voltage protection means is further connected to said switch means, and disables said switch means, thus disabling the flow of current flowing through said switch means to said equipment on said load side, when said current responsive means blows or disengages due to said surge voltage or current exceeding said predetermined value.

9. The method claimed in claim 8, wherein said switch means is an electromechanical device.

10. The method claimed in claim 8, wherein said switch means is a solid-state switch means.

11. The method claimed in claim 8, wherein said current responsive means is a manually resettable, mechanical or electromechanical circuit-breaker.

12. The method claimed in claim 8, wherein said switch means and said current responsive means is a circuit break switch.

13. The method claimed in claim 8, wherein said at least one over voltage detection or suppression means is a Metal Oxide Varistor (MOV),

14. The method claimed in claim 8, wherein the surge protector plug further includes an indicator connected across said load side and said earth ground to indicate a presence of power.
